(19) United States
(12) Patent Application Publication
(10) Pub. No.: US 2026/0303555 A1
(43) Pub. Date: Oct. 1, 2026

(54) STORAGE MEDIUM, INFORMATION PROCESSING APPARATUS, AND METHOD FOR CONTROLLING INFORMATION PROCESSING APPARATUS FOR REGISTERING AN IMAGE AS A STAMP USED IN CHAT APPLICATION

(71) Applicant: CANON KABUSHIKI KAISHA, Tokyo (JP)

(72) Inventor: JUNJI KAWATA, Tokyo (JP)

(21) Appl. No.: 19/573,839

(22) Filed: Mar. 20, 2026

(30) Foreign Application Priority Data
Mar. 31, 2025 (JP) 2025-057894

(51) Int. Cl. H04L 51/10; G06F 3/04817; G06N 3/0475; G06T 11/00; H04L 51/04

(52) U.S. Cl. CPC H04L 51/10; G06F 3/04817; G06N 3/0475; G06T 11/00; H04L 51/04

(57) ABSTRACT

A non-transitory computer-readable storage medium storing a program for causing a processor of an information processing apparatus to execute receiving information from a user, inputting the received information to an image generative Artificial Intelligence (AI), displaying, on a display, an image generated by the image generative AI based on the input information, and performing display control to cause the display to display an object to register the image displayed on the display as a stamp used in chat application executing on the information processing apparatus.

### BACKGROUND

### Field of the Technology

The present disclosure relates to a storage medium, an information processing apparatus, and a method for controlling the information processing apparatus.

### Description of the Related Art

An Artificial-Intelligence-Generated Content system (AIGC or generative artificial intelligence) is known to generate an image by using a keyword input by a user. With the AIGC system, for example, a prompt including a character string of natural language is input as a keyword (see US2023/0267652A1). The AIGC system generates an image including objects corresponding to the prompt input by the user. Simply by inputting a prompt to the AIGC system, the user is able to acquire an image including objects, such as persons and vehicles, corresponding to the prompt.

Japanese Patent No. 2024-007900 describes a technique in which a sketch is input to a generative AI to generate an image based on the sketch.

However, it has been troublesome for the user to perform an operation for registering an image generated by a generative AI, as a stamp of a chat application.

### SUMMARY

According to an aspect of the present disclosure, a non-transitory computer-readable storage medium storing a program for causing a processor of an information processing apparatus to execute receiving information from a user, inputting the received information to an image generative Artificial Intelligence (AI), displaying, on a display, an image generated by the image generative AI based on the input information, and performing display control to cause the display to display an object to register the image displayed on the display as a stamp used in chat application executing on the information processing apparatus.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a system configuration according to a present embodiment.

FIG. 2 is a block diagram illustrating a hardware configuration of a mobile terminal according to the present embodiment.

FIG. 3 is a block diagram illustrating a software configuration of the mobile terminal according to the present embodiment.

FIG. 4 is a block diagram illustrating a hardware configuration of a chat server according to the present embodiment.

FIG. 5 is a diagram illustrating a user interface of the mobile terminal according to the present embodiment.

FIG. 6 is a diagram illustrating the user interface of the mobile terminal according to the present embodiment.

FIG. 7 is a diagram illustrating the user interface of the mobile terminal according to the present embodiment.

FIG. 8 is a diagram illustrating the user interface of the mobile terminal according to the present embodiment.

FIG. 9 is a diagram illustrating the user interface of the mobile terminal according to the present embodiment.

FIG. 10 is a diagram illustrating the user interface of the mobile terminal according to the present embodiment.

FIG. 11 is a diagram illustrating the user interface of the mobile terminal according to the present embodiment.

FIG. 12 is a diagram illustrating a user interface of the mobile terminal according to the present embodiment.

FIG. 13 is a diagram illustrating the user interface of the mobile terminal according to the present embodiment.

FIG. 14 is a diagram illustrating the user interface of the mobile terminal according to the present embodiment.

FIG. 15 is a flowchart illustrating processing of the mobile terminal according to the present embodiment.

FIG. 16 is a flowchart illustrating processing of the mobile terminal according to the present embodiment.

### DESCRIPTION OF THE EMBODIMENTS

Hereinafter, embodiments of the present disclosure will be described in detail with reference to the accompanying drawings. The following embodiments are not intended to limit the present disclosure as defined by the claims, and not all combinations of features described in these embodiments are essential to the solutions of the present disclosure.

### Embodiment

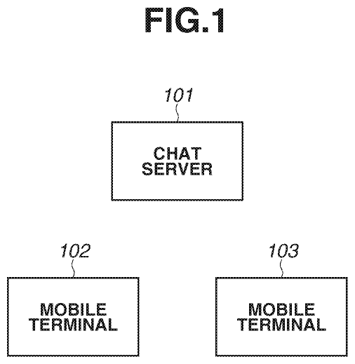

FIG. 1 is a diagram illustrating an example of a system configuration according to the present embodiment.

The system configuration includes a chat server 101 and mobile terminals 102 and 103.

The mobile terminal 102 wirelessly communicates with the chat server 101 via a base station.

The mobile terminal 103 also wirelessly communicates with the chat server 101 via the base station.

The user of the mobile terminal 102 posts messages and stamps to the chat server 101 by operating the mobile terminal 102. The user of the mobile terminal 103 can receive and display messages and stamps that have been posted to the chat server 101, by operating the mobile terminal 103.

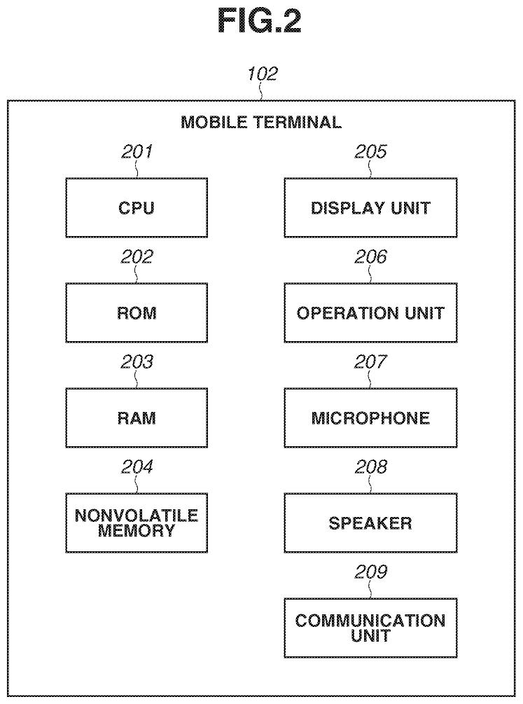

FIG. 2 is a diagram illustrating a hardware configuration of the mobile terminal 102 as an example of an information processing apparatus. The mobile terminal 103 has a hardware configuration similar to that of the mobile terminal 102.

The mobile terminal 102 includes a Central Processing Unit (CPU) 201, a Read Only Memory (ROM) 202, a Random Access Memory (RAM) 203, a nonvolatile memory 204, a display unit 205, an operation unit 206, a microphone 207, a speaker 208, and a communication unit 209.

The CPU 201 performs overall control of the mobile terminal 102. The CPU 201 may perform processing in cooperation with a Graphics Processing Unit (GPU).

The ROM 202 stores various programs to be read by the CPU 201.

The RAM 203 functions as a work memory of the CPU 201.

A nonvolatile memory 204 retains data even after the power of the mobile terminal 102 is turned off.

The display unit 205 displays screens, messages, stamps, and other various information. The CPU 201 performs display control for the display unit 205.

The operation unit 206 is a touch panel integrally configured with the display unit 205. The operation unit 206 receives various operations from the user. The operation unit 206 may be provided with hardware keys, such as a home key, for turning the screen on and off, and a power key for turning the power of the mobile terminal 102 on and off.

The microphone 207 receives sound information, such as the user's voice and environmental sound.

The speaker 208 outputs a sound.

The communication unit 209 performs wireless communication via Wi-Fi and the like.

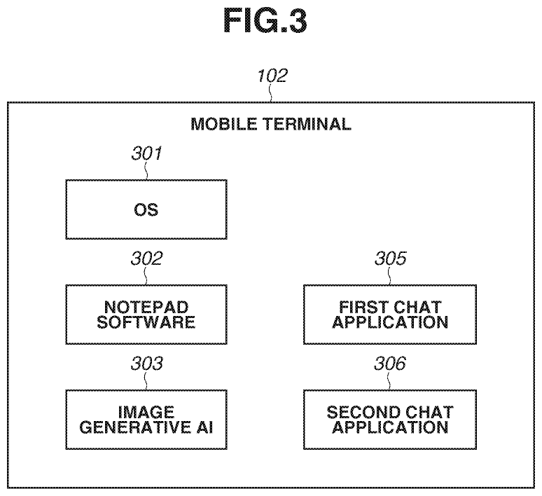

FIG. 3 is a diagram illustrating a software configuration of the mobile terminal 102. These pieces of software are stored in the nonvolatile memory 204, and loaded into the RAM 203 and executed by the CPU 201. An operating system (OS) 301 may be stored in the ROM 202. The mobile terminal 103 has a software configuration similar to that of the mobile terminal 102.

The mobile terminal 102 includes the OS 301, notepad software 302, an image generative AI 303, a first chat application 305, and a second chat application 306.

The OS 301 is basic software for using applications and the like. The OS 301 manages and controls various parts and programs operating in the mobile terminal 102.

The notepad software 302 is software for enabling the user to record a note using characters and/or figures. The notepad software 302 is included with the OS 301 and is pre-installed on the mobile terminal 102 at the time of purchase of the mobile terminal 102.

The image generative AI 303 is an AI for generating an image based on input character information and a learned model. The image generative AI 303 can also generate an image based on input graphic information and a learned model.

The first chat application 305 and the second chat application 306 are application software for enabling the user to post messages and stamps.

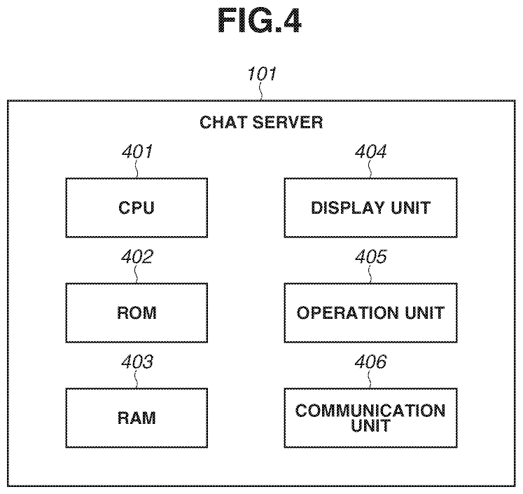

FIG. 4 is a block diagram illustrating a hardware configuration of the chat server 101.

The chat server 101 includes a CPU 401, a ROM 402, a RAM 403, a display unit 404, an operation unit 405, and a communication unit 406.

The CPU 401 performs overall control of the mobile terminal 102. The CPU 401 may perform processing in cooperation with a GPU.

The ROM 402 stores various programs to be read by the CPU 401.

The RAM 403 functions as a work memory of the CPU 401.

The display unit 404 displays screens.

The operation unit 405 includes a keyboard and a mouse. The operation unit 405 receives various operations from the user.

The communication unit 406 performs wired communication via a Local Area Network (LAN) cable and wireless communication via Wi-Fi and the like.

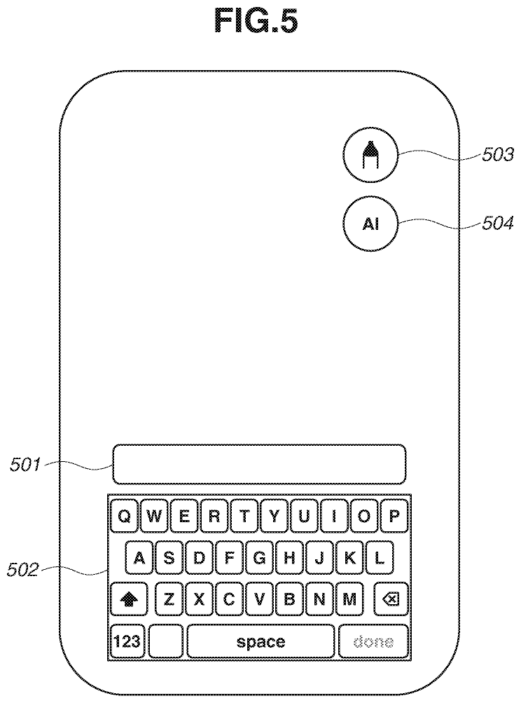

FIGS. 5 to 11 are diagrams illustrating the display unit 205 of the mobile terminal 102.

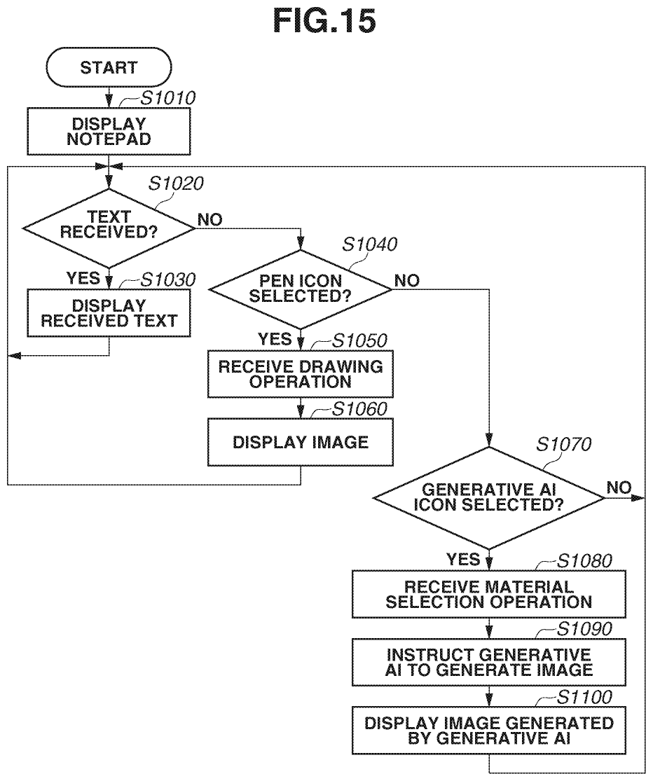

FIG. 15 is a flowchart illustrating processing according to the present embodiment. The processing of the flowchart illustrated in FIG. 15 is implemented when the CPU 201 loads a program stored in the ROM 202 into the RAM 203 and executes the program.

In step S1010, the CPU 201 executes the notepad software 302 to display a notepad screen illustrated in FIG. 5 on the display unit 205. The notepad screen includes a text input field 501, a keyboard 502, a pen icon 503, and a generative AI icon 504. These objects are operated by the user via the touch panel of the operation unit 206.

In step S1020, the CPU 201 determines whether text has been received via the operation unit 206. In a case where the CPU 201 determines that text has been received (YES in step S1020), the processing proceeds to step S1030. In a case where the CPU 201 determines that no text has been received (NO in step S1020), the processing proceeds to step S1040.

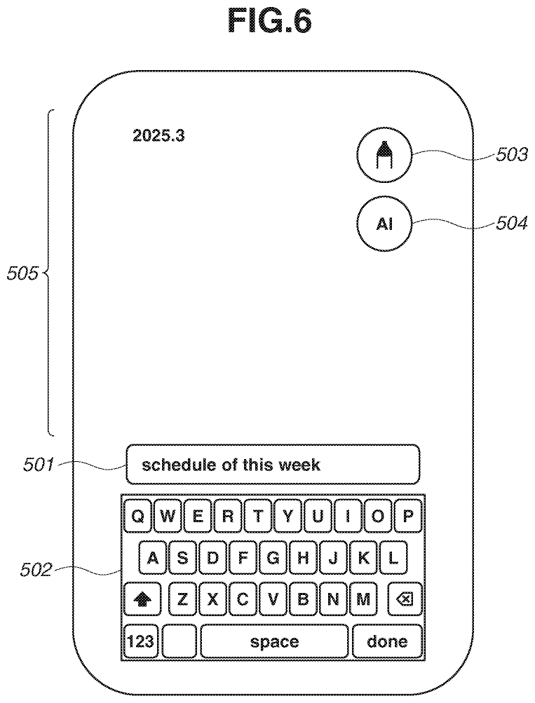

In step S1030, as illustrated in FIG. 6, the CPU 201 displays in the text input field 501 a character string input via the keyboard 502. When a done key of the keyboard is pressed with a character string input in the text input field 501, the character string input in the text input field 501 is displayed on a display area 505. After completion of the processing in step S1030, the processing proceeds to step S1020.

In step S1040, the CPU 201 determines whether the pen icon 503 has been selected.

In a case where the CPU 201 determines that the pen icon 503 has been selected (YES in step S1040), the processing proceeds to step S1050. In a case where the CPU 201 determines that the pen icon 503 has not been selected (NO in step S1040), the processing proceeds to step S1070.

In step S1050, the CPU 201 receives a drawing operation from the user.

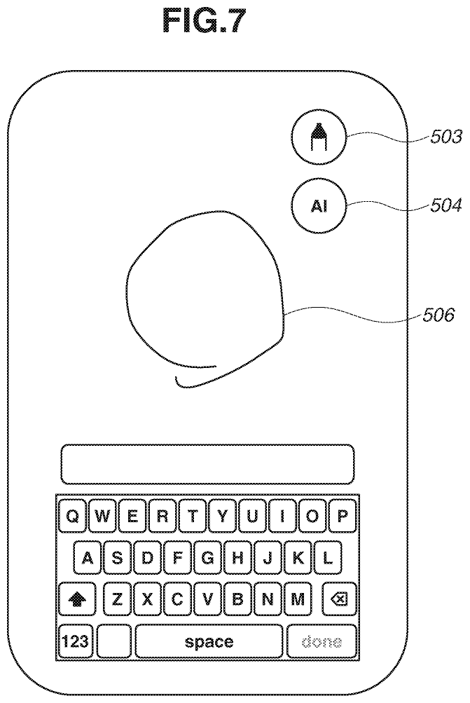

In step S1060, the CPU 201 displays a handwritten sketch image drawn with the drawing operation received in step S1050 in the display area 505. FIG. 7 is a diagram illustrating a state where a circle drawn with the drawing operation in step S1050 is displayed on the screen in step S1060. After completion of the processing in step S1060, the processing returns to step S1020.

In step S1070, the CPU 201 determines whether the generative AI icon 504 has been selected. In a case where the CPU 201 determines that generative AI icon 504 has been selected (YES in step S1070), the processing proceeds to step S1080. In a case where the CPU 201 determines that the generative AI icon 504 has not been selected (NO in step S1070), the processing returns to step S1020.

In step S1080, the CPU 201 receives a material selection operation for causing the image generative AI 303 to generate an image. Examples of the material include drawn images, characters input in the text input field 501 via the keyboard 502, and handwritten characters. A case where a circle 506 illustrated in FIG. 7 has been selected as a material will be described below.

In step S1090, the CPU 201 instructs the image generative AI 303 to generate an image.

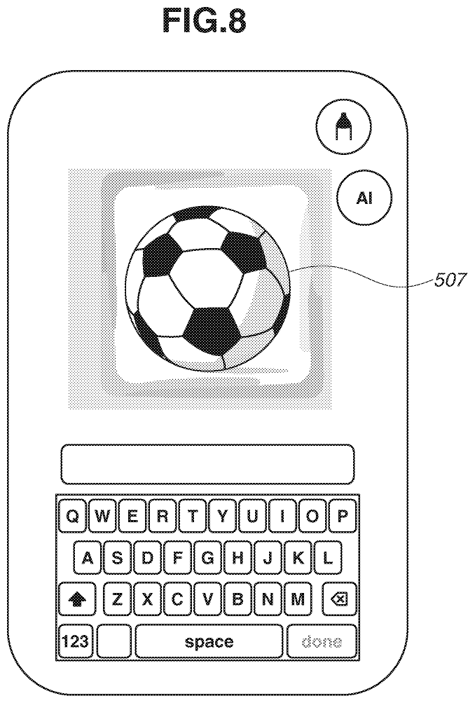

In step S1100, the CPU 201 displays the image generated by the image generative AI 303 on the display unit 205. An image 507 of a soccer ball illustrated in FIG. 8 is an example of an image generated by using the circle 506 as a material by the image generative AI 303.

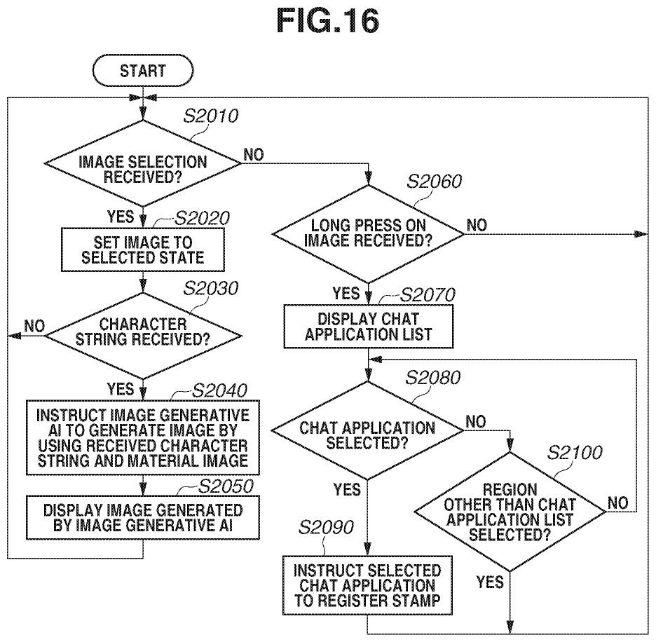

FIG. 16 is a flowchart illustrating the processing according to the present embodiment. The processing of the flowchart in FIG. 16 is implemented when the CPU 201 loads a program stored in the ROM 202 into the RAM 203 and executes the program.

In step S2010, the CPU 201 determines whether a selection of the image 507 generated by the image generative AI 303 has been received. In a case where the CPU 201 determines that a selection of the image 507 has been received (YES in step S2010), the processing proceeds to step S2020. In a case where the CPU 201 determines that a selection of the image 507 has not been received (NO in step S2010), the processing proceeds to step S2060. In step S2020, the CPU 201 sets the image 507 to a selected state.

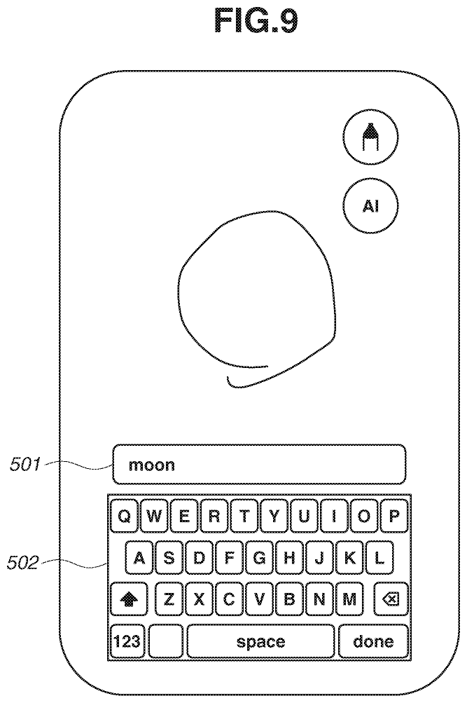

In step S2030, the CPU 201 determines whether a character string has been received. In a case where the CPU 201 determines that a character string has been received (YES in step S2030), the processing proceeds to step S2040. In a case where the CPU 201 determines that no character string has been received (NO in step S2030), the processing returns to step S2010. FIG. 9 is a diagram illustrating an example case in which a character string has been received.

In step S2040, the CPU 201 instructs the image generative AI 303 to generate an image by using the received character string and the image of the material.

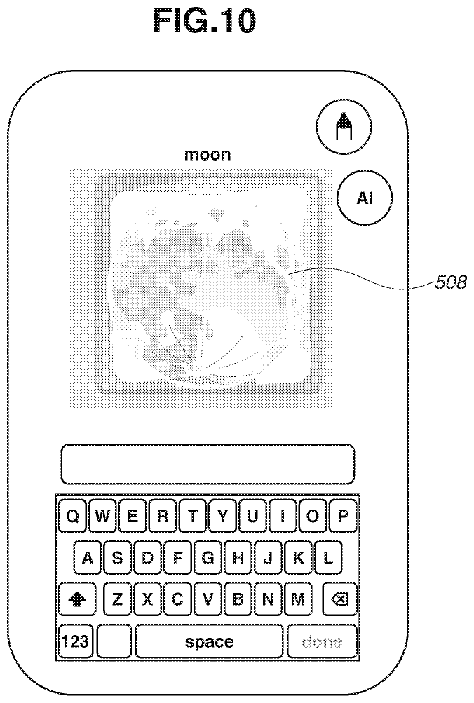

In step S2050, the CPU 201 displays an image generated by the image generative AI 303 on the display unit 205. FIG. 10 is a diagram illustrating an example of an image 508 generated in step S2050. The example is a case in which the CPU 201 has caused the image generative AI 303 to generate the image 508 based on a character string “moon” and the material, which is the circle 506, and displayed the image 508 generated by the image generative AI 303 on the display unit 205. Then, the processing returns to step S2010.

In step S2060, the CPU 201 determines whether a long press performed on the image has been received (whether the image is kept being touched for a predetermined time duration). In a case where the CPU 201 determines that no long press on the image has been received (NO in step S2060), the processing returns to step S2010. In a case where the CPU 201 determines that a long press performed on the image has been received (YES in step S2060), the processing proceeds to step S2070.

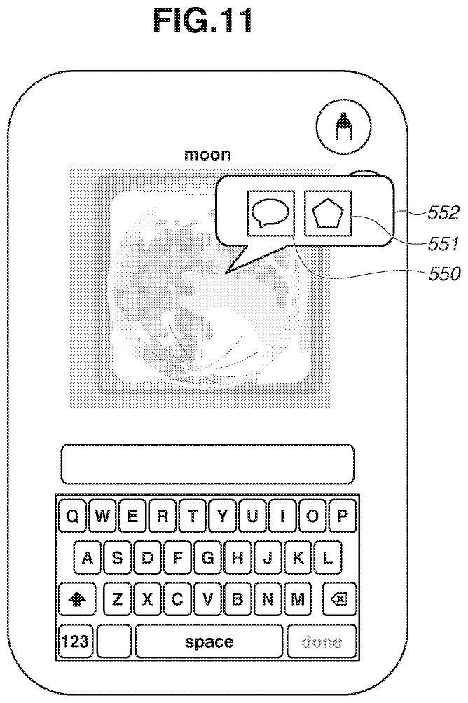

In step S2070, the CPU 201 displays a chat application list 552 in the display area 505 on the display unit 205. Information about each chat application included in the chat application list 552 has been stored in the nonvolatile memory 204 as application information when each chat application has been installed in the mobile terminal 102. For example, an icon of each chat application displayed in the chat application list 552 has been stored in the nonvolatile memory 204. The CPU 201 refers to the information in the nonvolatile memory 204 and displays the chat application list 552 including the icon corresponding to each chat application on the display unit 205. FIG. 11 is a diagram illustrating an example in which the chat application list 552 is displayed. The chat application list 552 illustrated in FIG. 11 includes an icon 550 of the first chat application 305 and an icon 551 of the second chat application 306. Although two icons are displayed in this example, three or more icons may be displayed in a case where a plurality of icons can be displayed.

In step S2080, the CPU 201 determines whether any one of chat applications in the chat application list 552 is selected by a selection of an icon. In a case where the CPU 201 determines that any one of the chat applications has been selected (YES in step S2080), the processing proceeds to step S2090. In a case where the CPU 201 determines that no chat application has been selected (NO in step S2080), the processing proceeds to step S2100.

In step S2090, the CPU 201 instructs the chat application selected by the selection of the icon to register the image generated by the image generative AI 303. In a case where the first chat application 305 has been selected by the selection of the icon 550 of the first chat application 305, the CPU 201 instructs the first chat application 305 to register the image generated by the image generative AI 303 as a stamp. In a case where the second chat application 306 has been selected by the selection of the icon 551 of the second chat application 306, the CPU 201 instructs the second chat application 306 to register the image generated by the image generative AI 303 as a stamp. Then, the processing proceeds to step S2010.

In step S2100, the CPU 201 determines whether an area other than the chat application list 552 has been selected. In a case where the CPU 201 determines that an area other than the chat application list 552 has been selected (YES in step S2100), the processing returns to step S2010. In a case where the CPU 201 determines that no area other than the chat application list 552 has been selected (NO in step S2100), the processing returns to step S2080.

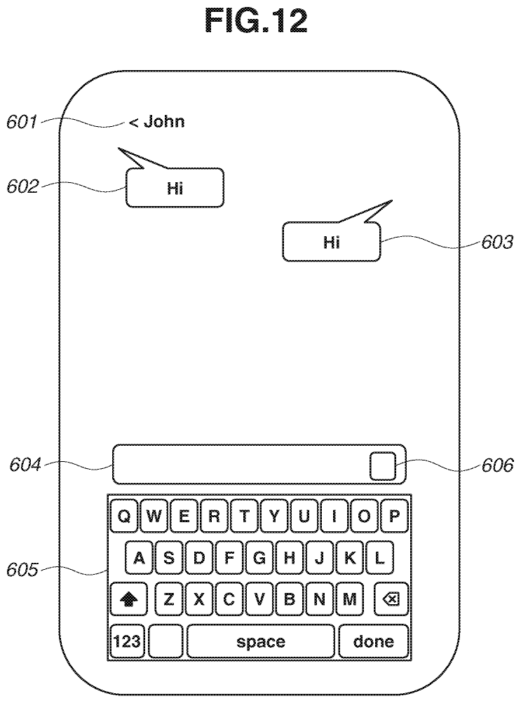

FIGS. 12 to 14 are diagrams each illustrating the display unit 205 of the mobile terminal 102. Each of FIGS. 12 to 14 illustrates a chat screen displayed by execution of the first chat application 305.

The chat screen displays a destination user 601, a received comment 602 from the destination user 601, and a comment 603 of a transmitting user.

The chat screen also displays a character string input area 604, a keyboard 605, and a stamp call button 606.

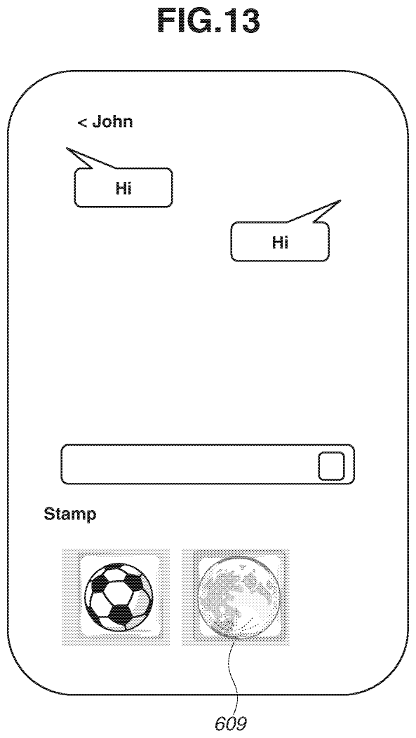

In response to the stamp call button 606 being selected, the screen illustrated in FIG. 13 is displayed. The screen illustrated in FIG. 13 displays a stamp 609 which has been registered in the first chat application 305 by the selection of the icon 550 illustrated in FIG. 11.

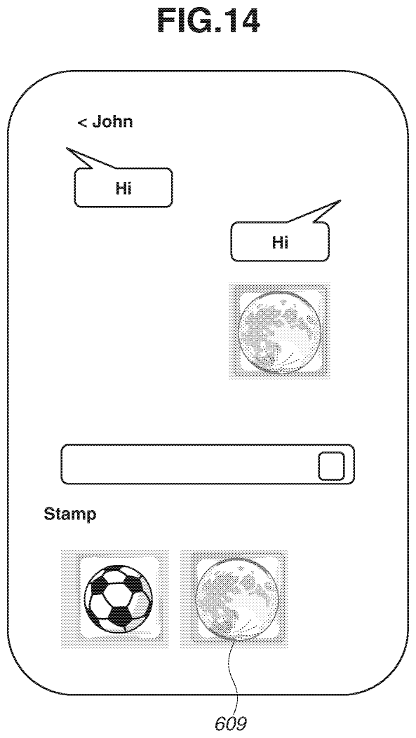

When the stamp 609 is selected in this state, the CPU 201 posts the stamp 609 to the chat server 101 as illustrated in FIG. 14.

As described above, according to the present embodiment, registration of the image generated by the generative AI to a chat application can be easily performed.

### Other Embodiments

In the above-described embodiments, in step S2090, the CPU 201 instructs the chat application selected by the selection of the icon to register the image generated by the image generative AI 303. Depending on a registration target chat application, a data format of registerable stamps may be predetermined. Therefore, the registration instruction may be issued after the CPU 201 changes the data format of the stamp in accordance with the selected chat application. The data format of registerable stamps for each chat application has been registered in the nonvolatile memory 204 by the CPU 201 as attribute information for the chat application when the chat application has been downloaded to the mobile terminal 102. Then, in response to the selection of the chat application, the CPU 201 acquires information about the data format of stamps registerable by the chat application from the nonvolatile memory 204. Based on the acquired information, the CPU 201 identifies the data format of stamps registerable by the selected chat application. The following is a description of a case in which a data format supported by the first chat application 305 is a Portable Network Graphics (PNG) file, and a data format supported by the second chat application 306 is a bitmap (BMP) file. For example, in a case where the first chat application 305 has been selected by a selection of the icon 550 of the first chat application 305, the CPU 201 converts the image generated by the image generative AI 303 into a PNG file. Then, the CPU 201 instructs the first chat application 305 to register the image having a size after the conversion, as a stamp. In a case where the second chat application 306 is selected by a selection of the icon 551 of the second chat application 306, the CPU 201 converts the image generated by the image generative AI 303 into a BMP file. Then, the CPU 201 instructs the second chat application 306 to register the image having a size after the conversion, as a stamp. The image generated by the image generative AI 303 can be converted and registered in accordance with the data format supported by the registration target chat application.

Further, depending on a selected chat application, the CPU 201 may change a data size of the image and issues the registration instruction. Vertical and horizontal sizes of registerable stamps for each chat application have been registered in the nonvolatile memory 204 by the CPU 201 as attribute information for the chat application when the chat application has been downloaded to the mobile terminal 102. In response to a selection of a chat application, the CPU 201 acquires information about the vertical and horizontal sizes of stamps registerable by the chat application from the nonvolatile memory 204. Based on the acquired information, the CPU 201 identifies the vertical and horizontal sizes of stamps registerable by the selected chat application. Depending on a registration target chat application, the vertical and horizontal sizes of registerable stamps may be predetermined. The following is a description of a case in which the first chat application 305 supports a size of 240 pixels in the vertical direction×240 pixels in the horizontal direction, and the second chat application 306 supports a size of 360 pixels in the vertical direction×360 in the horizontal direction. For example, in a case where the first chat application 305 has been selected by a selection of the icon 550 of the first chat application 305, the CPU 201 changes the size of the image generated by the image generative AI 303 to a first size (240 pixels in the vertical direction×240 pixels in the horizontal direction). Then, the CPU 201 instructs the first chat application 305 to register the image having the size after the change as a stamp. In a case where the second chat application 306 has been selected by a selection of the icon 551 of the second chat application 306, the CPU 201 changes the size of the image generated by the image generative AI 303 to a second size smaller than the first size. In this case, the second size is 360 pixels in the vertical direction×360 pixels in the horizontal direction. Then, the CPU 201 instructs the second chat application 306 to register the image having the size after the change as a stamp. In a case where the size of stamps managed by the first chat application 305 is limited to the first size, and the size of stamps managed by the second chat application 306 is limited to the second size, stamps in accordance with these sizes can be generated and registered.

The data size of registerable images may be limited depending on the registration target application. Thus, the CPU 201 may change the data size of an image in accordance with the selected chat application and issue the registration instruction. The data size of registerable stamps for each chat application has been registered in the nonvolatile memory 204 by the CPU 201 as attribute information for the chat application when the chat application has been downloaded to the mobile terminal 102. In response to a selection of a chat application, the CPU 201 acquires information about the data size of stamps registerable by the chat application from the nonvolatile memory 204. Based on the acquired information, the CPU 201 identifies the data size of stamps registerable by the selected chat application. The following is a description of a case in which the data size of each image is limited to 1 megabyte (MB) for the first chat application 305, and the data size of each image is limited to 2 MB for the second chat application 306. In this case, depending on the selected chat application, the CPU 201 may check whether the data size of the image subjected to a registration instruction exceeds the data size of images registerable to the selected chat application, and issue a registration instruction. For example, in a case where the first chat application 305 has been selected by a selection of the icon 550 of the first chat application 305, the CPU 201 determines whether a data size of the image generated by the image generative AI 303 exceeds 1 MB. In a case where the CPU 201 determines that the data size does not exceed 1 MB, the CPU 201 instructs the first chat application 305 to register the image as a stamp. In a case where the CPU 201 determines that the data size exceeds 1 MB, the CPU 201 notifies the display unit 205 of an error indicating that the image is not registerable. In a case where the second chat application 306 has been selected by a selection of the icon 551 of the second chat application 306, the CPU 201 determines whether a data size of the image generated by the image generative AI 303 exceeds 2 MB. In a case where the CPU 201 determines that the data size does not exceed 2 MB, the CPU 201 instructs the second chat application 306 to register the image as a stamp. In a case where the CPU 201 determines that the data size exceeds 2 MB, the CPU 201 notifies the display unit 205 of an error indicating that the image is not registerable. In the above-described way, the CPU 201 can check the upper limit of the data size of registerable stamps before registering a stamp to the chat application. In a case where a stamp is not registerable, the user can easily recognize the error by the error message.

Alternatively, when a chat application is selected, the CPU 201 may perform determination of whether a content of the image generated by the image generative AI 303 is registerable as a stamp. In a case where the CPU 201 determines that the content of the image generated by the image generative AI 303 is registerable as a stamp, the CPU 201 instructs the selected chat application to register the image as a stamp. In a case where the CPU 201 determines that the content of the image generated by the image generative AI 303 is not registerable as a stamp, the CPU 201 displays an error indicating that the image is not registerable, on the display unit 205. Examples of the content being not registerable include an image only with pale colors and a simple enumeration of numbers.

The present disclosure can also be implemented by supplying a program that realizes one or more functions of the above-described embodiments to a system or apparatus via a network or a storage medium, and causing one or more processors of a computer in the system or apparatus to read and execute the program. Furthermore, the disclosure can also be implemented by a circuit (for example, an ASIC) that realizes one or more functions.

While desirable embodiments of the present disclosure have been described above, the present disclosure is not limited to these embodiments, and various modifications and changes can be made within the scope of the gist of the disclosure.

According to the present disclosure, an image generated by a generative AI is easily registered as a stamp of a chat application.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-057894, filed Mar. 31, 2025, which is hereby incorporated by reference herein in its entirety.

What is claimed is:

1. A non-transitory computer-readable storage medium storing a program for causing a processor of an information processing apparatus to execute:
receiving information from a user;
inputting the received information to an image generative Artificial Intelligence (AI);
displaying, on a display, an image generated by the image generative AI based on the input information; and
performing display control to cause the display to display an object to register the image displayed on the display as a stamp used in chat application executing on the information processing apparatus.

2. The non-transitory computer-readable storage medium according to claim 1, wherein, performing display control causes the object to be displayed when the image is displayed on the display is selected by the user.

3. The non-transitory computer-readable storage medium according to claim 1, wherein, performing display control causes the object to be display when the image displayed on the display is touched for a predetermined time duration.

4. The non-transitory computer-readable storage medium according to claim 1, wherein execution of the program by the processor further causes the information processing apparatus to execute displaying a plurality of icons of a plurality of chat applications on the display in the display control, and instructing a chat application corresponding to an icon selected from the plurality of icons by the user to register the image as a stamp when the image displayed on the display is selected by the user.

5. The non-transitory computer-readable storage medium according to claim 1,
wherein the information processing apparatus has notepad software executing thereon, and
wherein the received information is received by the notepad software.

6. The non-transitory computer-readable storage medium according to claim 5, wherein the information is text.

7. The non-transitory computer-readable storage medium according to claim 5, wherein the information is a handwritten character.

8. The non-transitory computer-readable storage medium according to claim 5, wherein the information is a handwritten image.

9. A method for controlling an information processing apparatus comprising:
receiving information from a user;
inputting the received information to an image generative Artificial Intelligence (AI);
displaying, on a display, an image generated by the image generative AI based on the input information; and
performing display control to cause the display to display an object to register the image displayed on the display as a stamp used in chat application executing on the information processing apparatus.

10. The method according to claim 9, wherein, performing display control causes the object to be displayed when the image is displayed on the display is selected by the user.

11. The method according to claim 9, wherein, performing display control causes the object to be display when the image displayed on the display is touched for a predetermined time duration.

12. The method according to claim 9 further comprising displaying, wherein a plurality of icons of a plurality of chat applications on the display in the display control and instructing a chat application corresponding to an icon selected from the plurality of icons by the user to register the image as a stamp when the image displayed on the display is selected by the user.

13. The method according to claim 9,
wherein the information processing apparatus has notepad software executing thereon, and
wherein the received information is received by the notepad software.

14. The method according to claim 13, wherein the information is text.

15. The method according to claim 13, wherein the information is a handwritten character.

16. The method according to claim 13, wherein the information is a handwritten image.

17. An information processing apparatus comprising:
a receiving unit configured to receive information from a user;
an inputting unit configured to input the information received by the receiving unit to an image generative Artificial Intelligence (AI);
a displaying unit configured to display, on a display, an image generated by the image generative AI based on the information input by the inputting unit; and
a display control unit configured to perform control to cause the display to display an object to register the image displayed on the display as a stamp used in chat application executing on the information processing apparatus.
